(19) United States
(12) Patent Application Publication
(10) Pub. No.: US 2020/0118092 A1
(43) Pub. Date: Apr. 16, 2020

(54) Built by Blockchain: A Universal API for Nonnative Cross Chain Smart Contracts

(71) Applicant: Paul Gauvreau, Rancho Santa Fe, CA (US)

(72) Inventor: Paul Gauvreau, Rancho Santa Fe, CA (US)

(21) Appl. No.: 15/920,423

(22) Filed: Mar. 13, 2018

(51) Int. Cl. G06Q 20/06; G06F 16/23; G06F 16/22; H04L 9/06

(52) U.S. Cl. CPC G06Q 20/065; G06F 16/2379; H04L 2209/38; H04L 9/0637; G06F 16/2246

(57) ABSTRACT

A BbyB architecture provides a novel architecture in which smart contracts can be made independently from the blockchain they are being built on. More specifically, the BbyB architecture acts as the middleman or exchange. It enables for diversified transactions to hedge the individual coins volatility, fraud, and specificity, while still maintaining the security of our immutable blockchains. In layman terms, it's a blockchain built on every other blockchain on the network.

### FIELD

Embodiments of the invention relate to the field of blockchain; and more specifically, to a universal API for non-native cross chain smart contracts.

### BACKGROUND

The blockchain provides for a method in which individuals can store immutable data and make anonymous transactions independent from third parties. However, it lacks a universal market or medium of transaction in which you can transfer and store any information in the Blockchain.

### BRIEF DESCRIPTION OF THE DRAWINGS

The invention may best be understood by referring to the following description and accompanying drawings that are used to illustrate embodiments of the invention. In the drawings:

FIG. 1 illustrates the processes in which the different blockchains will be hashed together.

FIG. 2 illustrates the structure in which all the individual chains are hashed together.

FIG. 3 illustrates the processes in which a smart contract is verified prior to being placed in a block.

FIG. 4 is a representation of the Smart Contract Chain structure. It displays some of the base components that compose a contract.

FIG. 5 illustrates the structure of an individual smart contract, and helps define the variables used.

FIG. 6 illustrates the different components composed in a smart contract's payment section.

FIG. 7 displays how an individual payment method is defined.

FIG. 8 illustrates process in which a payment is received, held, and released as a contract is Verified.

FIG. 9 displays how the payment aspect of a contract is verified.

FIG. 10 illustrates the different components composed in a smart contract's Rules and Condition section.

FIG. 11 displays how an individual Rule/Condition is defined.

FIG. 12 displays how the different rules are hashed together on verification. Each time a rule or payment is verified, it is hashed and the contents of that contract are updated.

FIG. 13A is one portion of a figure that displays how the different rules and conditions in a smart contract are verified and processed.

FIG. 13B is another portion of a figure that displays how the different rules and conditions in a smart contract are verified and processed.

FIG. 14 illustrates the process in which a verified contracts identification and status are hashed together on a state of closure.

FIG. 15 displays the process in which smart contracts are created, signed, and added to the different chains.

FIG. 16 displays the contents and structure of each Cross Chain BbyB Block.

FIG. 17 illustrates how the Cross Chain BbyB Blocks are hashed together.

FIG. 18 displays the encryption process structured for each contract created.

FIG. 19 displays how the hash tree is decomposed to reduce the data being stored.

FIG. 20 displays the process in which a ‘dead’ contract is transferred for long term storage.

FIG. 21 illustrates how a smart contract is transferred and processed after being verified.

FIG. 22 displays the procedure used to generate smart contracts and finalize smart contracts.

### DESCRIPTION OF EMBODIMENTS

The blockchain is a revolutionary method in data storage that enables immutable public records. With the rise of cryptocurrencies, there is an increase in fraud, volatility, and inability to make seamless transactions for nonnative chain functions. The objective of this experiment is to provide a system and mechanism in which one can create nonnative cross chain smart contracts. More specifically, this is a cross chain API that enables nonnative applications to be built across preexisting blockchains by facilitating exchanges and referencing data from multiple chains. This is significant, as no one has created cross chain applications or universal blockchains, and this experiment is a vital step towards a third party less global economy, as it provides an unmanned, immutable, blockchain based exchange.

The Idea behind The Blockchain is that it enables immutable records, meaning it's a trusted method of storing data that can't be hacked, but more importantly, The Blockchain provides major advancements in transactions between two anonymous parties. However, the limitation of modern cryptocurrencies and blockchains is that they are built for very specific tasks. This is where the BbyB architecture comes in to play, as it provides a novel architecture in which smart contracts can be made independently from the blockchain they are being built on. More specifically, the BbyB architecture acts as the middleman or exchange. It enables for diversified transactions to hedge the individual coins volatility, fraud, and specificity, while still maintaining the security of our immutable blockchains. In layman terms, it's a blockchain built on every other blockchain on the network.

In conclusion, the BbyB architecture provides a universal medium for nonnative ubiquitous transactions, while removing the risk associated with volatility, providing for seamless duel party transactions.

This project is a vital step towards a third party less economy and stable, universal transactions, public records, and data storage. By enabling cross chain contracts, customizable payloads, and diversification, the BbyB architecture provides a mechanism in which two independent parties can make reliable, anonymous, and unique contracts. It enables for diversification of data and investment to hedge volatility and long term stability. Ultimately, it removes the middleman and provides the architecture for the restructuring of everyday exchanges. But what's really unique about the project is its ability to pull in and reference all the other blockchains and create cross chain contracts.

This project is significant as it provides a novel architecture in which there is a universal medium for nonnative ubiquitous transaction. It removes the risk associated with volatility, providing for seamless duel party transactions.

Smart Contracts

The smart contracts enable people to make ubiquitous two party transactions of physical goods and services. By building the smart contracts on blockchain based technology, the Built by Blockchain architecture provides a system in which individuals can create immutable and trusted records, helping to remove the distrust associated with unknown individuals and enabling for a high pace, seamless duel party agreement. More specifically, the Built by Blockchain architecture and smart contracts provide a major breakthrough in third party less transactions by enabling a system in which they can be built across any pre-existing blockchain or cryptocurrency. Ultimately, enabling anyone to buy and sell, goods and services, anonymously and independently from any third party.

Think of amazon, it serves as the middleman between consumers and online retailers, enabling registered individuals to purchase goods from unknown counterparts. However, current data structures are inefficient and the third party, Amazon, has the ability to monopolize the market, restricting some individuals from being able to buy and sell goods and services. The BbyB architecture and smart contracts provide for a system in which no one party is restricted from transacting with another, all data is stored publically, and has equivalent trust factors of buying a good through an established third party like Amazon, enabling for a truly, free market economy and trade.

The smart contracts work by defining a series of rules and conditions required for a transaction to take place. They enable for a mechanism in which two parties can transact with one another by removing the distrust. All rules are predefined and electronically verifiable macros that the correspondents see fit to confirm and facilitate their transaction.

Multi-Chain Protocol

The Built by Blockchain architecture provides a structure in which each chain is linked together, similar to a Merkle Root. This provides for a fully modular blockchain based API and enables for custom post transaction and post escrow functions. The custom chain implementation provides a method in which institutions can easily apply custom blockchain solutions.

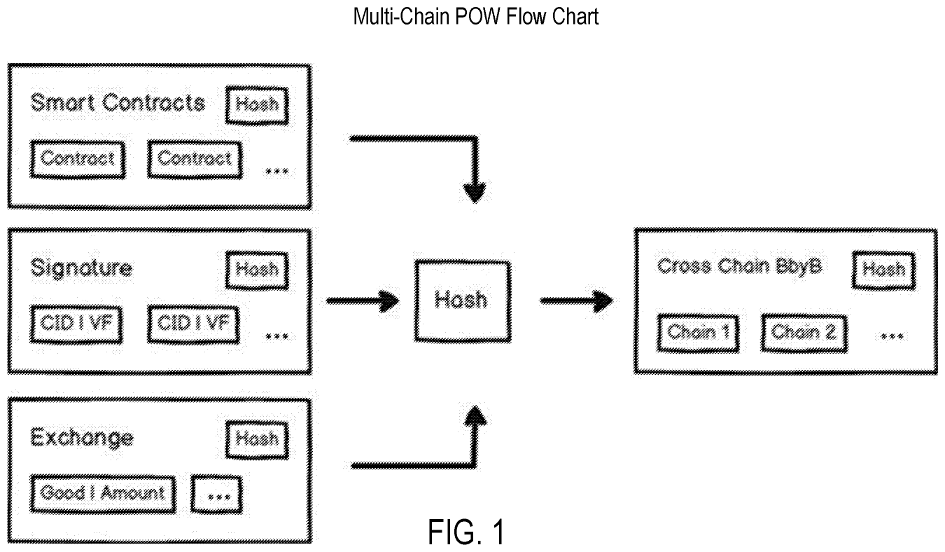

FIG. 1 illustrates the processes in which the different blockchains will be hashed together. Each chain operates independently from one another, but has the capacity to work in conjunction with any other chain in the system and those not incorporated into the BbyB architecture. The chains act as different applets built into and on top of the BbyB API.

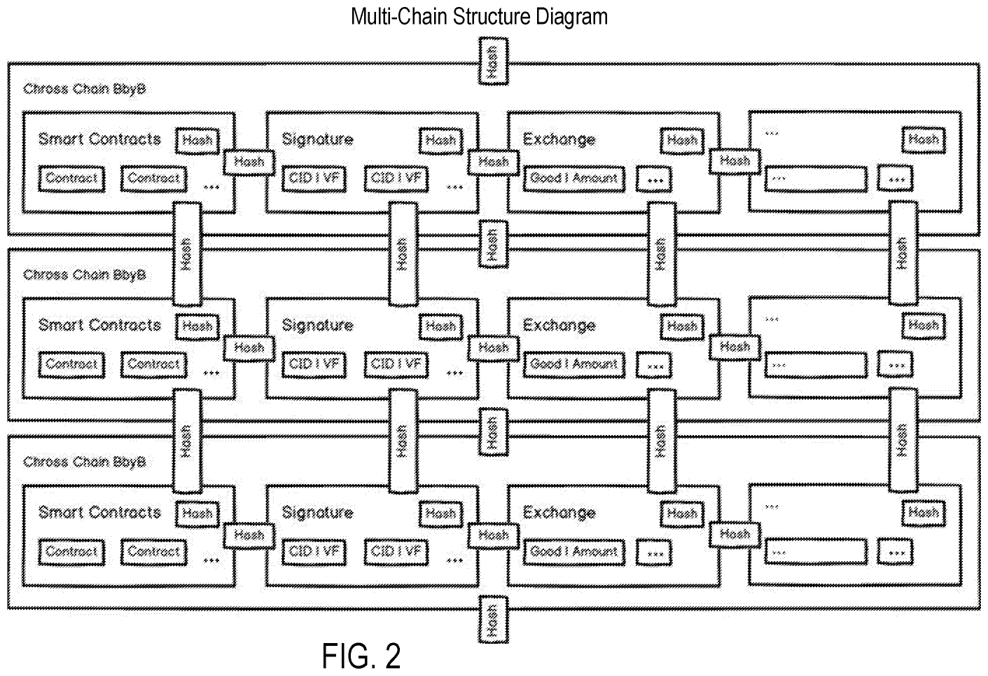

FIG. 2 illustrates the structure in which all the individual chains are hashed together.

Fundamental chains:
Contract Chain
   The contract chain serves as the foundational system for storing an immutable record of contracts made between two parties
Verification Chain
   To prevent from people amending their contracts midterm and trying to submit duplicate [contracts], all contracts are verified and monitored in a parallel chain. This increases the security and reliability of the contracts generated by exponentially increasing the computational power required to alter past records, and preventing false terminations.

API Based applications:
Exchange Chain
   Similarly to modern cryptocurrencies, the exchange based blockchain provides a distributed ledger of goods available for sale. It enables for businesses and individuals to create ubiquitous smart contracts without a facilitating third party

Contract Creation Verification System and Processor

The verification system is structured very similarly to how transactions are added and approved in a cryptocurrency.

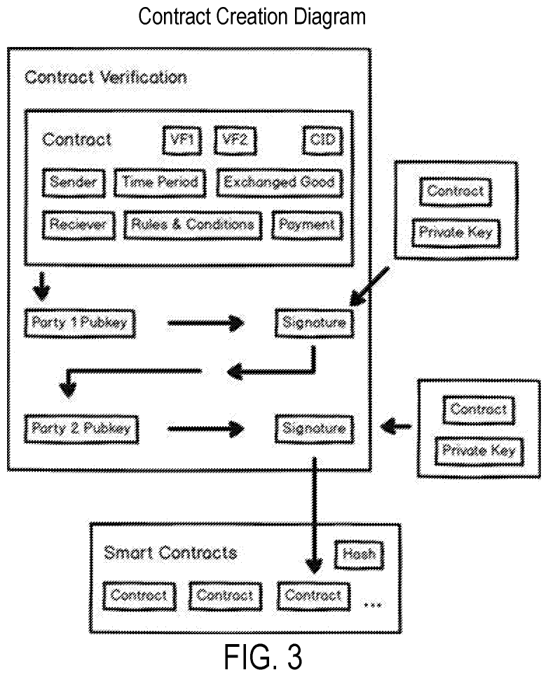

FIG. 3 illustrates the processes in which a smart contract is verified prior to being placed in a block.
To initiate the contract creation process, the sending party will fill out the contract and submit it, during this process all rules, fees, and other terms are defined and saved to the object.
After the initial party finalizes their contract, it is digitally signed with their private address and then sent over to the receiving party to verify and accept the terms.
When the contract is first sent, an initial fee is collected for the creation of a contract.
After the receiving party agrees and signs the contract with their private key, the contracts is then published to the most up to date node.

Contract Structure

The contract structure is left fully modular to enable them to be used for anything from the most ubiquitous good or service to the most complex transaction.

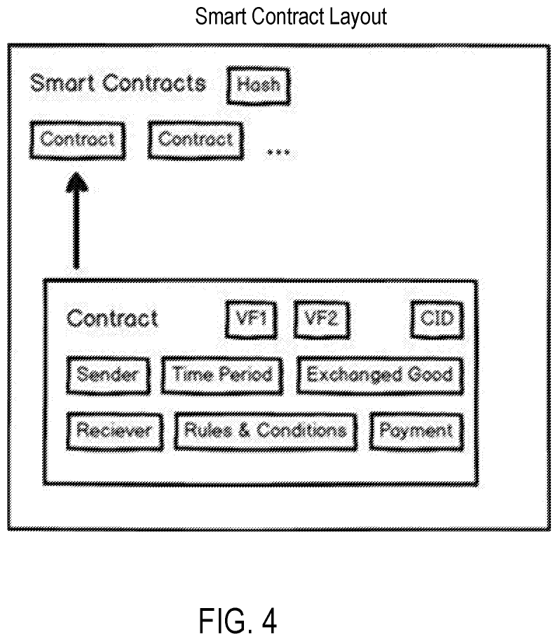

FIG. 4 is a representation of the Smart Contract Chain structure. It displays some of the base components that compose a contract.

A contract is divided up into nine different sections:
The first two sections are time stamped references of when each party made mutual agreements to abide by the contract conceived
The third section is an identification number to differentiate one contract from another
The fourth section is used to identify the sending party in the contract. This field contains the sender's public address and their public encryption key. The fifth section is used to identify the receiving party in the contract. This field also contains the sender's public address and their public encryption key.
The sixth section it series of terms in which define the period in which the contract must be carried out before it is rendered invalid
The seventh section is used to define the good/service being transacted. This field contains information and references that would enable a non-mutual individual to identify the object.
The eighth section is used to define the payment aspect of the contract. This includes the public addresses of both the senders and receivers cryptocurrency wallets. A payment guide that includes the different cryptocurrencies being used and the amount due. [After being processed, the payments are updated to include the transaction fees associated with each coin and the contract itself]
The ninth section includes the rules and conditions required for the transaction to be processed. This field includes a series of rules and electronically verifiable macro that are used to determine if a contract has been fulfilled/violated.

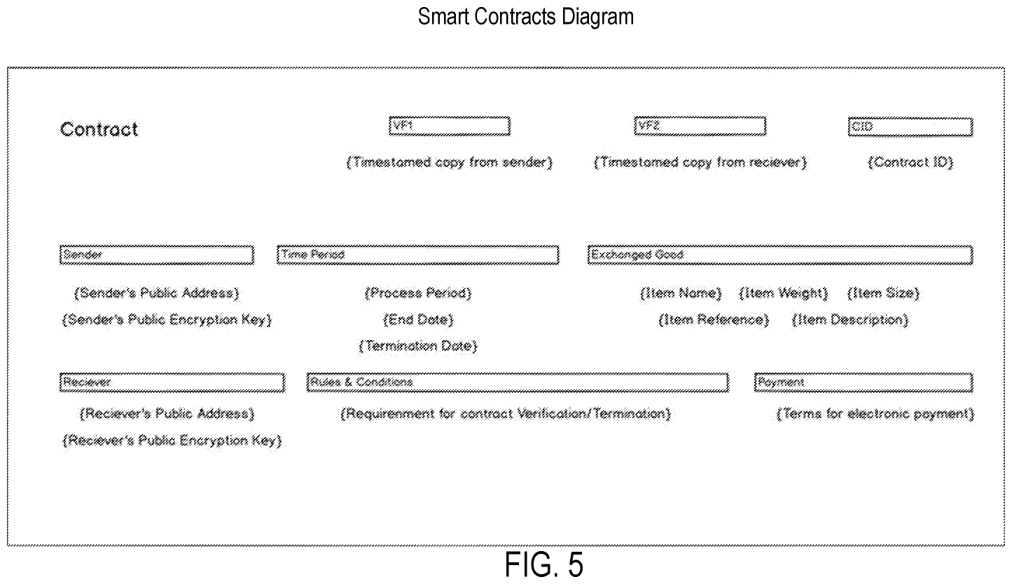

FIG. 5 illustrates the structure of an individual smart contract, and helps define the variables used.

Payment Verification

The payment verification system plays a major role in processing the different smart contracts, by verifying transactions being placed, it enables for a tracked payment method. The payment verification process differentiates the BbyB blockchain architecture from every other chain out there by enabling it to cross reference information and transactions from other blockchains.

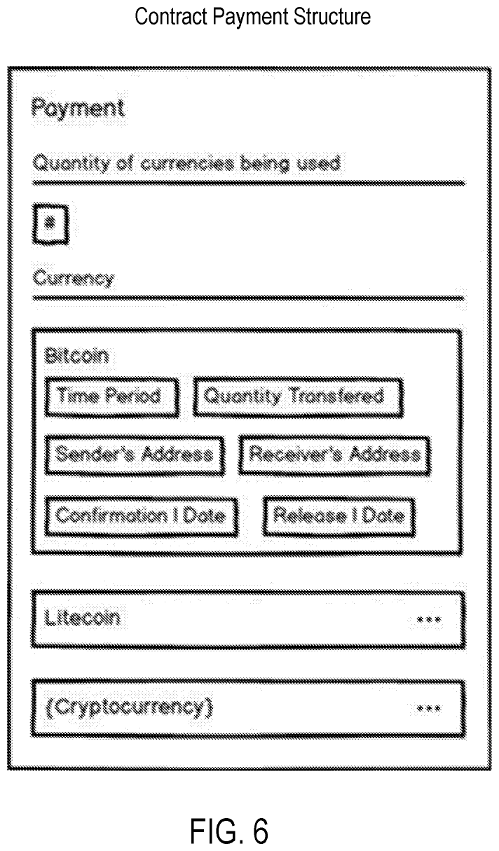

FIG. 6 illustrates the different components composed in a smart contract's payment section.

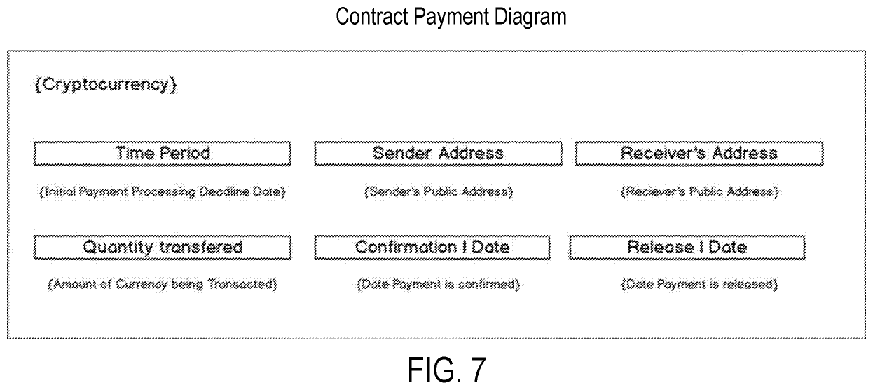

FIG. 7 displays how an individual payment method is defined.

For example, when verifying a payment method or transaction of funds, the sending party can use any cryptocurrency available because the trusted distributed ledgers they act as enable the system to monitor and verify the transaction occurred. It does this by decrypting the blocks generated by other cryptocurrencies and screening for the desired transaction. This enables for a two point verification system.

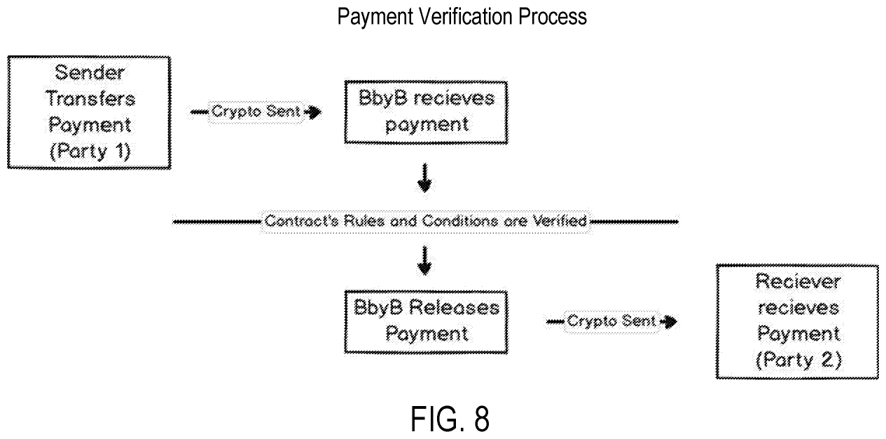

FIG. 8 illustrates process in which a payment is received, held, and released as a contract is Verified.

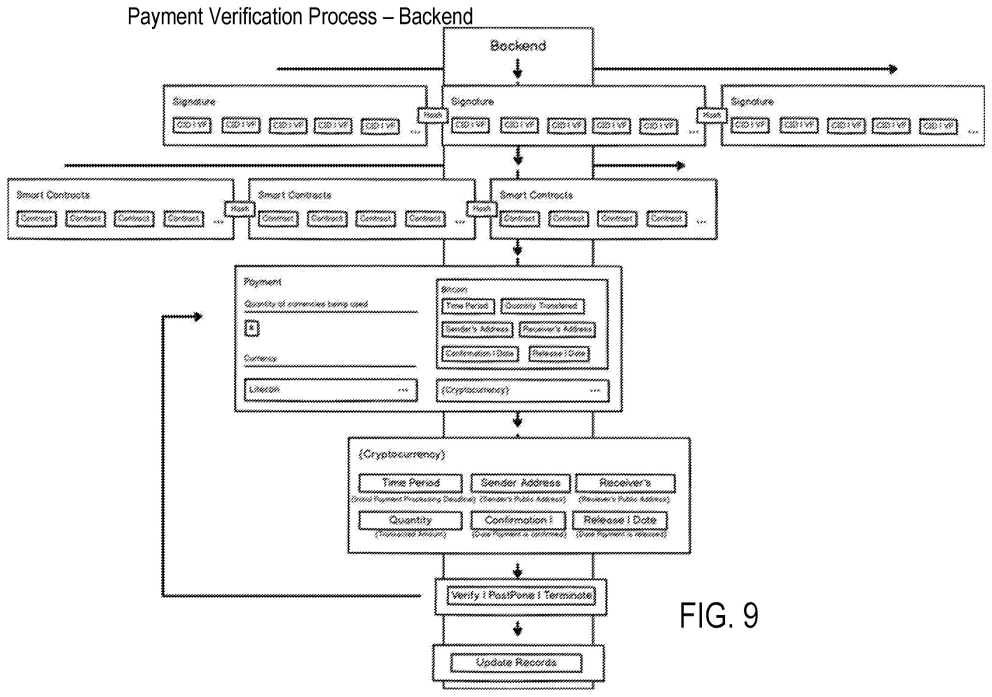

FIG. 9 displays how the payment aspect of a contract is verified.

Rules and Conditions

The rules function as a verification method in which one can check to see if a contract has been filled or breached. They act as a series of requirement in order for the transaction to be processed and escrow to be closed.

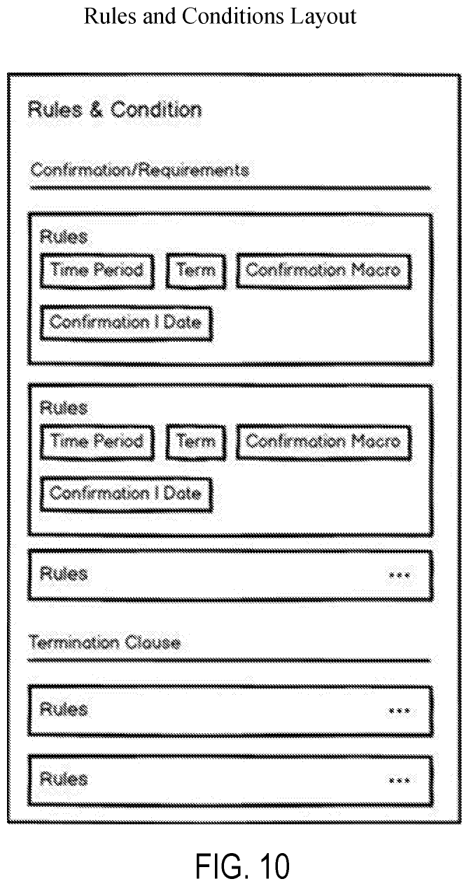

FIG. 10 illustrates the different components composed in a smart contract's Rules and Condition section.
Rules must be able to be electronically verified
Rules must be very black and white, requiring no interpretation
Rules are stored chronologically in which they will be processed
Rules can be used to both verify that a contract has been carried out, and they can be used to terminate the contract, by determining if it's been breached. Rules can be used to both verify that a contract has been carried out, and they can be used to terminate the contract, by determining if it's been breached.

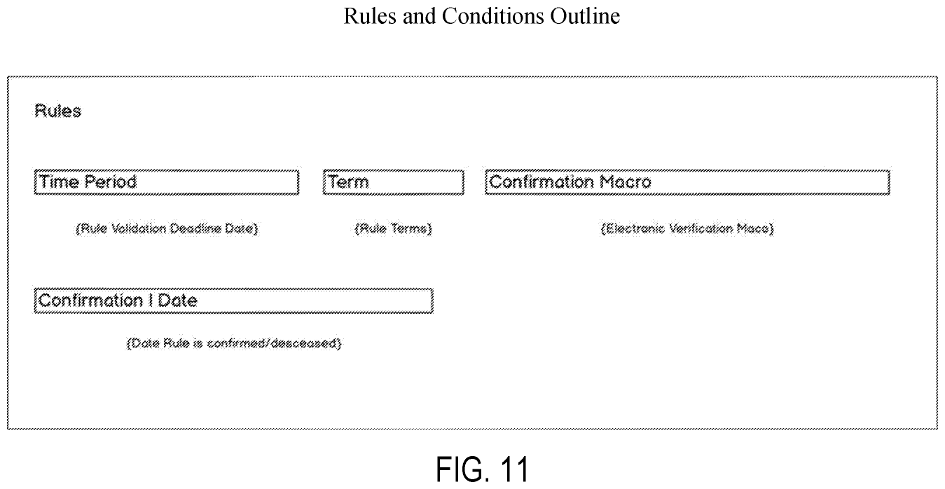

FIG. 11 displays how an individual Rule/Condition is defined.

Rule Verification

Every time a new block is added to the BbyB chain, the verification chain is parsed, and processed by the BbyB servers. The Verification Status (VF) of each outstanding contract is updated by using that particular contracts CID (Contract Identification Number) to locate and parse its corresponding records in the Smart Contracts Chain.

Outstanding contracts are updated by referencing the time period in which the contract must be completed, the payment requirements, and the rules/conditions of the contract. Each section is parsed to verify compliance. In the case in which a term has been violated, the contract is terminated and its status is updated.

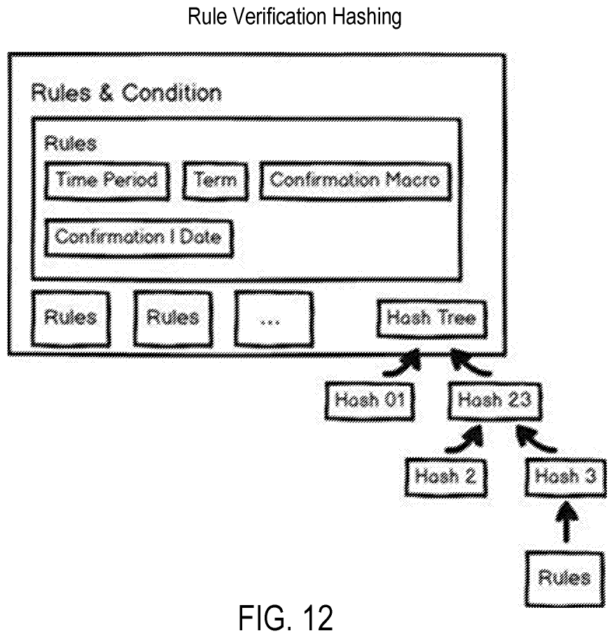

FIG. 12 displays how the different rules are hashed together on verification. Each time a rule or payment is verified, it is hashed and the contents of that contract are updated.

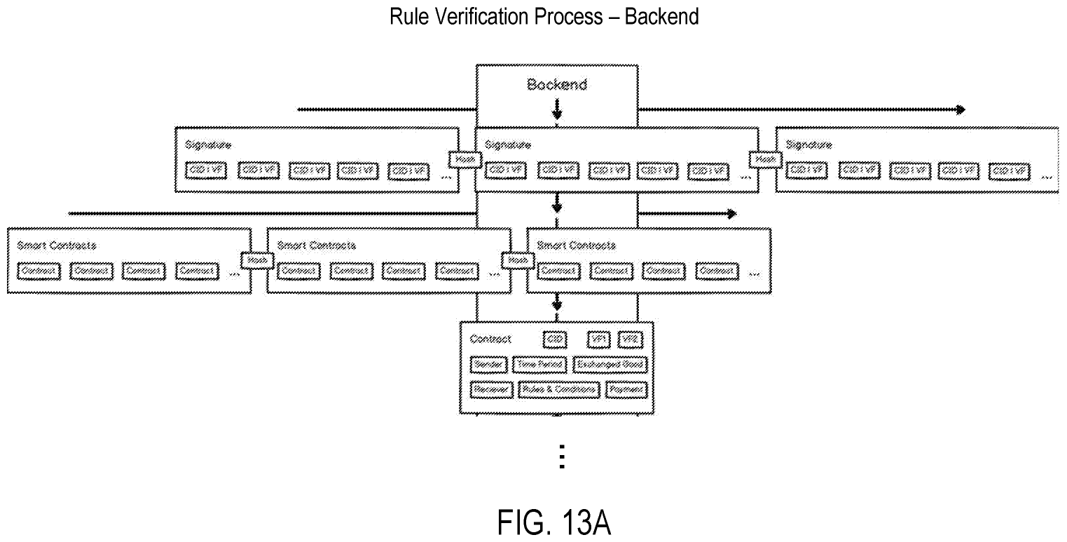

FIG. 13 displays how the different rules and conditions in a smart contract are verified and processed.

Transaction Closure

Once all of the rules are verified and the final branched is hashed, all hashes are doubled checked and the verification status of that particular contract is updated, sealing the tree and transferring the contract into its state of closure.

When the contract enters a state of closure, it will take two chain iterations to finalize the agreement. After the initial status is updated and the block is sealed, the funds are released and the block is transferred to a long term storage chain to help optimize the verification of live contracts and keep systems optimal (this is further discussed in the Reclamation of Disk Space/Proof of Transaction Section).

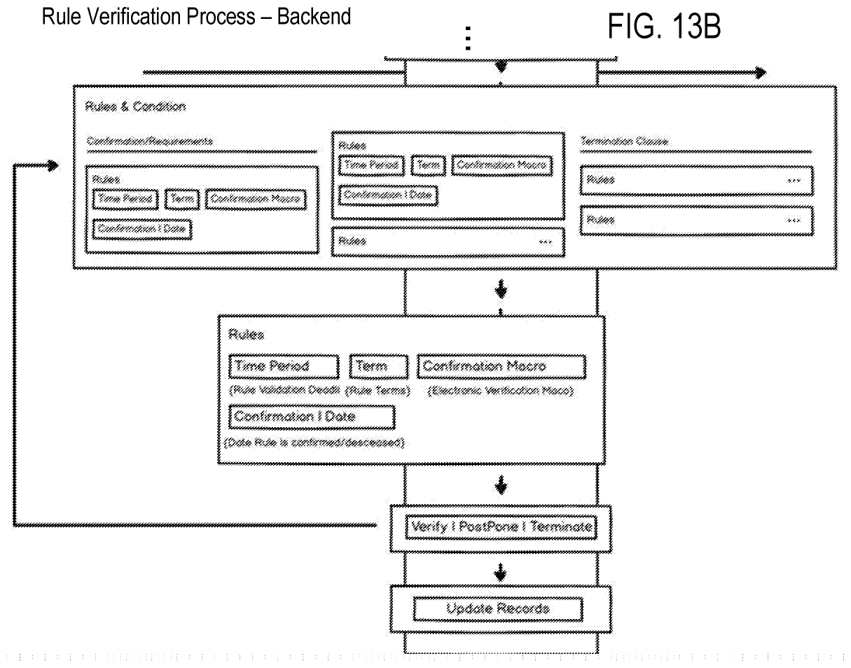

FIG. 14 illustrates the process in which a verified contracts identification and status are hashed together on a state of closure.

Timestamp

Timestamps play a major role in blockchain security by drastically altering the hashes generated. They legitimize records, while providing for a very universally understood measurement. The timestamp server functions to validate blocks taking record of the previous blocks timestamps.

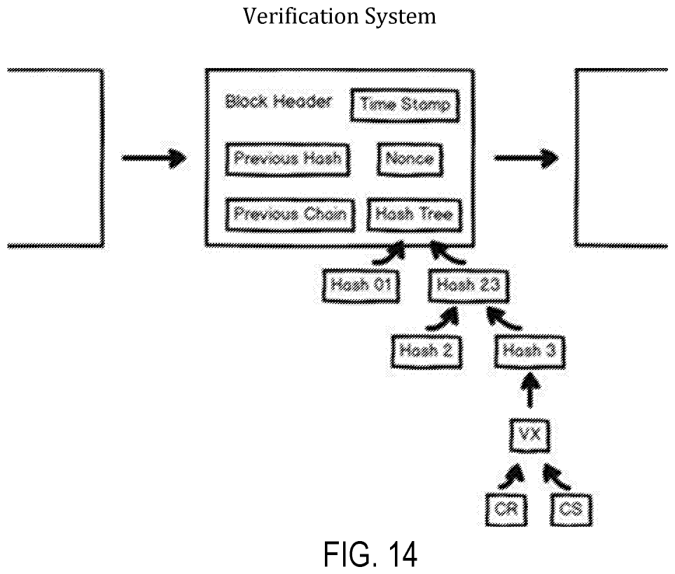

FIG. 15 displays the process in which smart contracts are created, signed, and added to the different chains.

The timestamp server is used to:
Sign, verify, and initiate new contracts
Verify pre-existing blocks
Validate new blocks
Validate content added to a block

Hash

Similarly to the cryptocurrencies, to implement the timestamp server and distributed records on a decentralized network, we will use hashes and proof of work based methods to immunate the data. POW based methods operate by using the previous hash from a validated block, and an incremented nonce to produce a non-factorable hash ending with x zero bits.

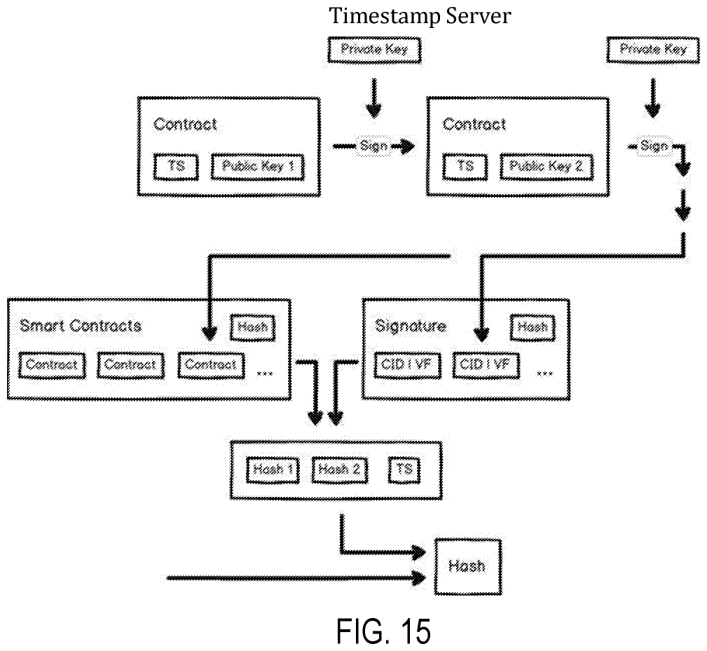

FIG. 16 displays the contents and structure of each Cross Chain BbyB Block.

As long as the node is maintained in honest hands, all contracts will stay truthful. Therefore, the incentives play a major role in the honest keeping of the chain, as miners must want to mine to maintain the chain then to alter contracts in their favor.

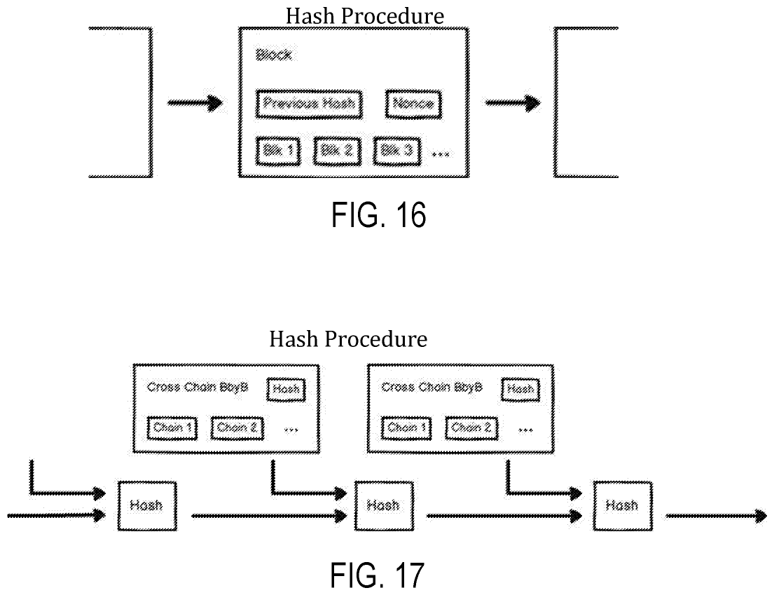

FIG. 17 illustrates how the Cross Chain BbyB Blocks are hashed together.

Privacy

Contracts are given the option to be encrypted similarly to how a two point SMS encryption is handled, both parties obtain private keys that enable them to decrypt the package. Therefore, without one of the encryption keys, Individuals would be unable to gather insight related to the contract being made.

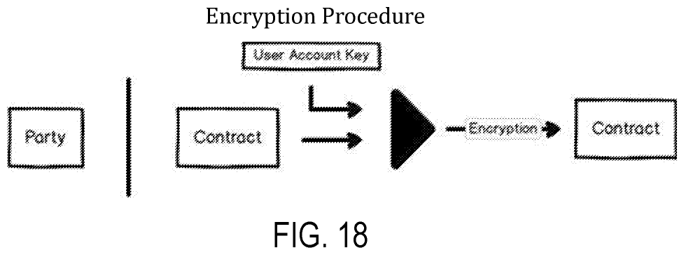

FIG. 18 displays the encryption process structured for each contract created.

In addition to encrypted contracts, each user will be assigned a private and public user ID, this will enable them to store information and create contracts privately from one another. This enables individuals to maintain anonymity. In the case that someone believes their private ID has been compromised, they can easily generate a new one.

Network

The network is structured in which:
New contracts are broadcasted across all preexisting nodes
Contracts are collected and assigned IDs
The contracts are then collected from the nodes to form a block, while their Contract IDs are collected to form a parallel system in which the contracts are signed and verified
Each node works on finding a Proof of Work for the individual chains and broadcasts it across all other nodes
Once the Proof of Work has been determined for all parallel chains and the blocks have been verified, Nodes work to find Proof of Work for the chains hashed together
   This enables for a fully modular blockchain based exchange where other can built alternative markets and customized response chains
Once the final Proof of Work is determined, the node broadcasts the updated chain and then they start working on the next block
Once all the contracts are verified and the rules are checked, a new block is started and funds are released.

Incentive

Since there is no coin associated with the Built by Blockchain architecture, miners earn profit through the transaction fees associated with creating contracts, processing funds, and verifying the rules put in place. This provides an incentive for nodes to support the network, and it provides reliable method in which the records can remain in an immutable state.

Exchange

The exchange servers as both a demonstration and application of the Built by Blockchain architecture. The exchange will be one of the additional chain using BbyB to facilitate its transactions. Furthermore, its content will be hashed in addition to the native BbyB chains.

As for the structure of the blockchain and how the data will be stored in the exchange, all goods available are contained in packets similarly to how transactions are placed in a cryptocurrency. Each object contains the Item, a description, optional image, price, and general shipment location, enabling for anyone to list and sell goods and services.

API

The Built by Blockchain API enables for individuals, companies, and organizations to create custom exchanges, markets, and ways of transferring goods and information. More specifically, the API enables for parties to embed the Built by Blockchain infrastructure and smart contract system into their own markets.

Reclaiming Disk Space

Once a contract has been terminated, the contract itself, and its verification file can be discarded to save disk space and optimize screening speed. However, in order to discard irrelevant records without breaking the blocks hash, the blocks are hashed together in a tree based format, making each additional object a branch. Therefore, once a contract becomes confirmed or terminated the branch can be discarded without breaking the blocks hash. This enables for a more compact block and data structure.

Reclamation of Disk Space

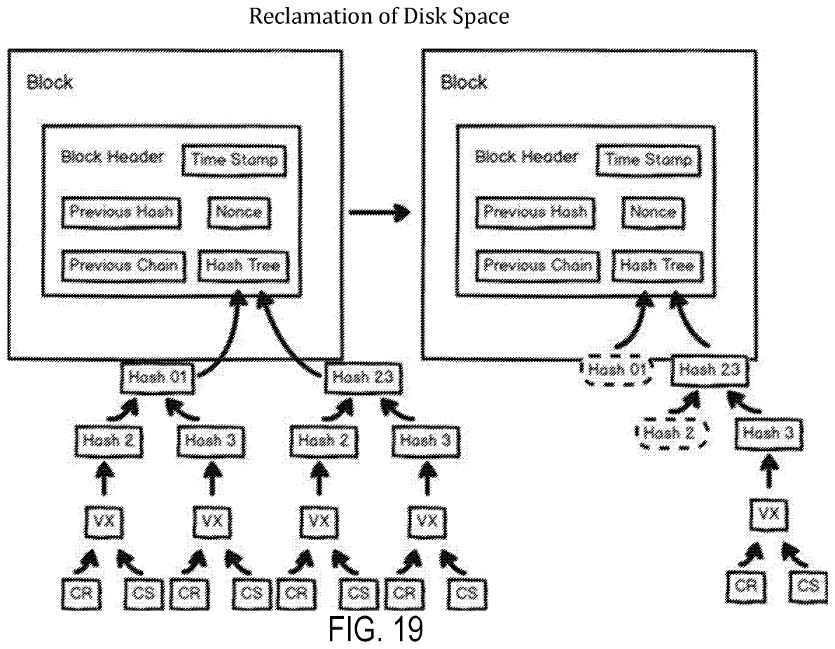

FIG. 19 displays how the hash tree is decomposed to reduce the data being stored.

Proof of Transaction

As the main Smart Contracts chain and its identifying Verification Chain grow, the memory required to buffer and verify live contracts grows drastically. Therefore, while the terminated contracts can just be discarded, the verified yet dead contracts are transferred to more long term storage based chain.

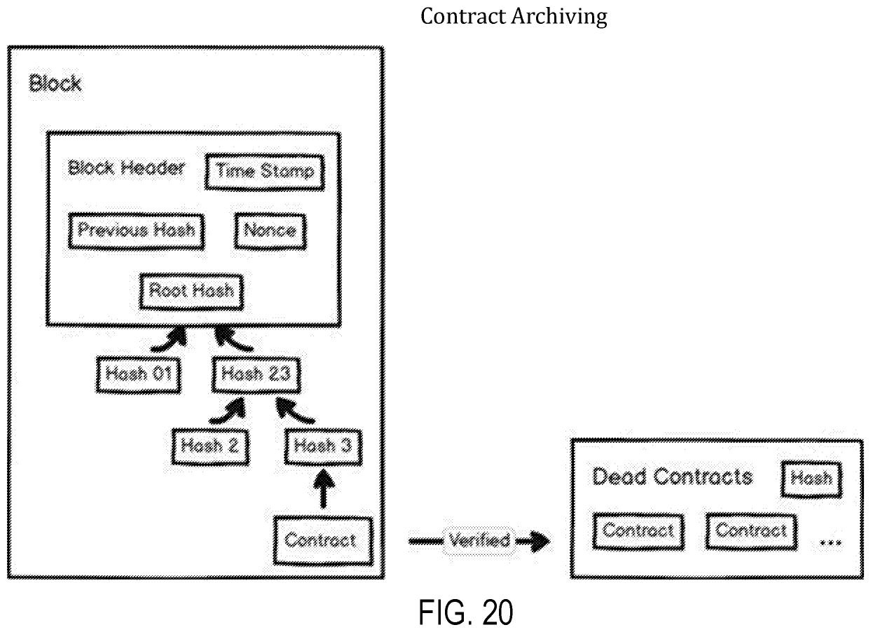

FIG. 20 displays the process in which a ‘dead’ contract is transferred for long term storage.

When a contract is verified and then sealed, the now dead contract is hashed and transferred to the long term storage chain, deleting it from both the Smart Contracts chain and the Verification chain.

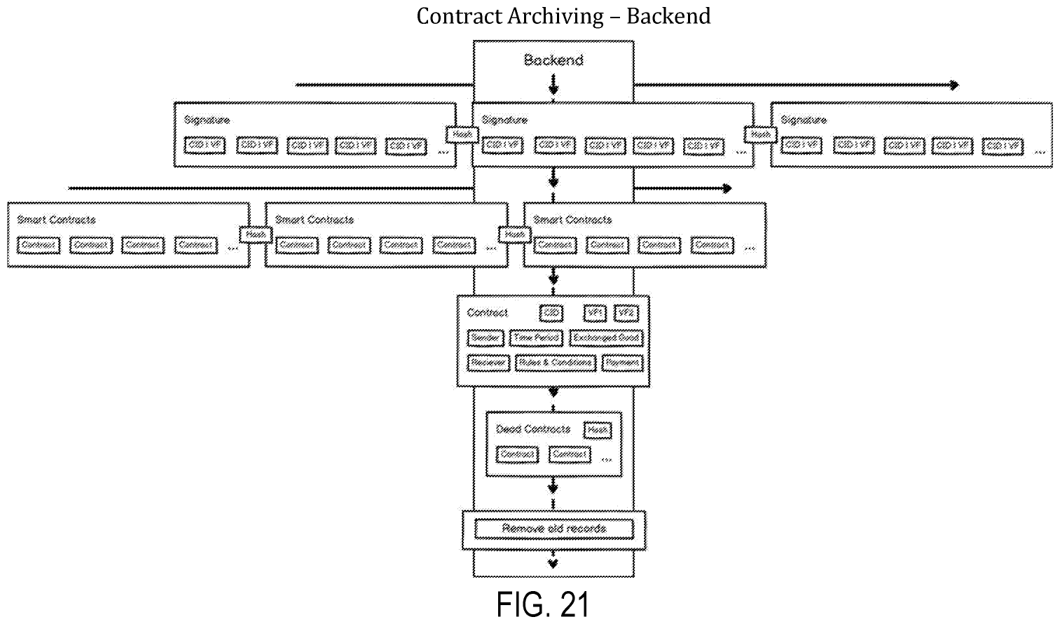

FIG. 21 illustrates how a smart contract is transferred and processed after being verified.

UI Interaction

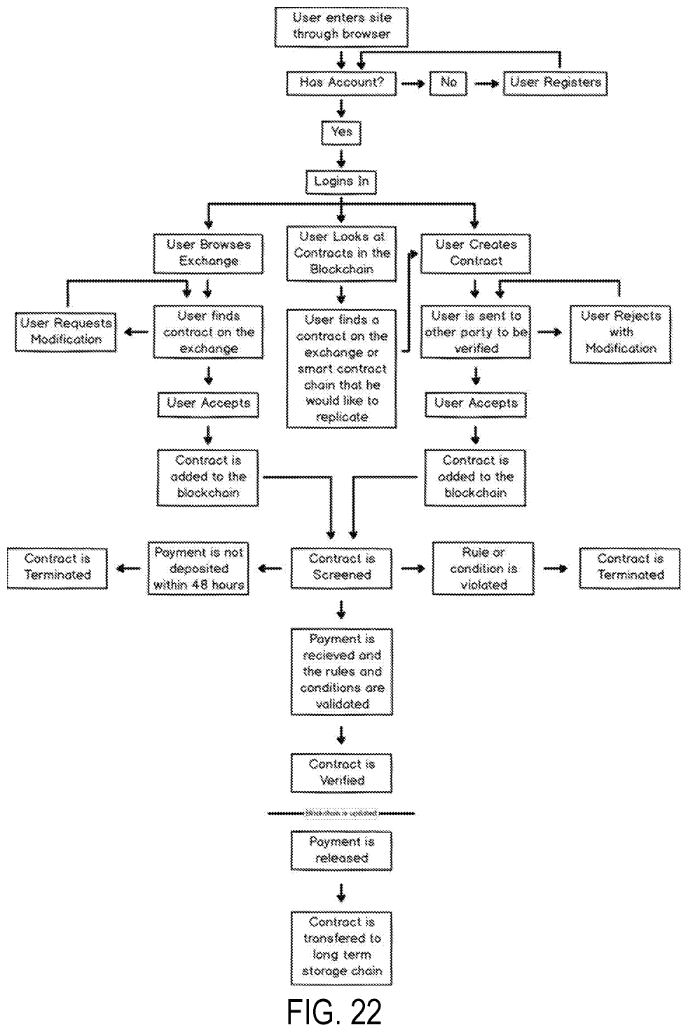

FIG. 22 displays the procedure used to generate smart contracts and finalize smart contracts.

### CONCLUSION

The blockchain provides for a method in which individuals can store immutable public records, and cryptocurrencies provide for a method in which individuals can transfer and track digital funds. The Built by Blockchain architecture provides a system in which these technologies are used to remove the distrust associated with buying and selling ubiquitous goods and services to unknown individuals. It enables third party less transactions by acting as the middleman and exchange. This project provides a novel architecture in which blockchains can are used to hold irregular objects and facilitate the transactions of ubiquitous goods. It revolutionizes the modern day market by enabling for two party based transactions.

This was achieved by designing a novel system in which a blockchain was built out of multiple different blockchains, enabling for accelerated readouts, increased specificity, and increased security. By dividing data storage, the BbyB architecture provides a fully modular system in which individuals can use the API to create custom applications and exchanges for the smart contracts. It provides an immutable autonomous system in which any party can create Smart contracts to facilitate their transactions.

The creation of a Smart Contract works similarly to how transactions occur in modern cryptocurrencies, every time a contract is created it must be signed off with each party's private key. After one party signs the contract, it can't be altered, meaning before the contract is published to a node, both parties must agree to terms and individually sign their contract. After the contract is created, its content is added to a series of different chains, the main two being the Smart Contract Chain, which houses the contract, and the Verification Chain, which keeps track of a contracts verification status. The Smart Contract is then added to the blockchain and the verification process begins.

When a contract is created, it is composed of a series of predefined terms, including time period or how long the contract is valid for, a series of rules and condition required to be completed for the contract to be verified, definitions of payment, and so on. This provides for a fully customizable contract in which individuals can clearly define their transaction, while enabling for easy to make contracts for ubiquitous goods and services.

One of the largest differences between the BbyB architecture, is that there is no coin tied to the blockchain, meaning that its sole function is to provide an immutable, unregulated, and trustworthy free market in which two party transactions can occur. Therefore, in order to process payment, the Built by Blockchain system is structured in which it can read and respond to the transactions made in other cryptocurrencies. More specifically, by decrypting the distributed ledgers, it can verify that transactions have occurred, and respond accordingly. After a contract is verified, it is transferred to a dormant, long term storage based chain and all the funds are released.

In conclusion, the Built by Blockchain architecture provides a novel system in which nonnative, ubiquitous smart contracts can be composed to facilitate two party transactions.

### REFERENCES

Information Propagation in the Bitcoin Network—IEEE Conference Publication, ieeexplore.ieee.org/abstract/document/6688704/?reload=true.
MedRec: Using Blockchain for Medical Data Access and Permission Management—IEEE Conference Publication, ieeexplore.ieee.org/abstract/document/7573685/.
HeinOnline, heinonline.org/HOL/LandingPage?handle=heinjournals/duklr65&div=17&id=&page=.
Securing Smart Cities Using Blockchain Technology—IEEE Conference Publication, ieeexplore.ieee.org/abstract/document/7828539/.
10207686163847664. “A Beginner's Guide to Blockchain—Hacker Noon.” Hacker Noon, Hacker Noon, 1 Jan. 2018, hackernoon.com/a-beginners-guide-to-blockchain-d04266844e7.
3 ways blockchain technology could revolutionize the law By Lauren Mack/guest. “3 Ways Blockchain Technology Could Revolutionize the Law.” Technical.ly Brooklyn, 12 Mar. 2018, technical.ly/brooklyn/2018/03/12/3-ways-blockchain-technology-revolutionize-law/.
@clay, Clayton Elliott, et al. “What Is Blockchain Technology? A Step-by-Step Guide For Beginners.” Blockgeeks, 6 Mar. 2018, blockgeeks.com/guides/what-is-blockchain-technology/.
“Bitcoin Guides Archive.” CoinDesk, www.coindesk.com/information/.
Brovkin, Dmytro. “How To Develop A Blockchain Application—The Startup—Medium.” Medium, The Startup, 8 Nov. 2017, medium.com/swlh/how-to-develop-a-blockchain-application-185bf8b7e7eb.
Galgani, Matthew. “Blockchain Deal With Ripple May Fuel New Breakout For Fleetcor|Stock News&amp; Stock Market Analysis—IBD.” Investor's Business Daily, Investor&#039;s Business Daily, 12 Mar. 2018, www.investors.comlresearch/ibd-stock-analysis/blockchain-ripple-fleetcor-deal-stocks-towatch/.
“Growing the Blockchain Information Infrastructure.” ACM Digital Library, ACM, dl.acm.org/citation.cfm?id=3025959.
Marr, Bernard. “A Complete Beginner's Guide To Blockchain.” Forbes, Forbes Magazine, 24 Jan. 2017, www.forbes.com/sites/bernardmarr/2017/01/24/a-complete-beginners-guide-toblockchain/#34697e226e60.
Miscione, et al. “Bitcoin and the Blockchain: A Coup D'État through Digital Heterotopia?” By Gianluca Miscione, Donncha Kavanagh: SSRN, 30 Jun. 2015, papers.ssrn.com/sol3/papers.cfm?abstract_id=2624922.
Olenski, Steve. “What The Blockchain Revolution Means For CMOs.” Forbes, Forbes Magazine, 12 Mar. 2018, www.forbes.com/sites/steveolenski/2018/03/12/what-the-blockchain-revolution-means-forcmos/#4b9942d46f5d.
Stephanian, Lauren. “From ‘What Is Blockchain?” to Building a Blockchain in Less than an Hour.” FreeCodeCamp, FreeCodeCamp, 29 Mar. 2017, medium.freecodecamp.org/from-what-isblockchain-to-building-a-blockchain-within-an-hour-4e738efc819d.
Wright, Aaron, and Primavera De Filippi. “Decentralized Blockchain Technology and the Rise of Lex Cryptographia.” By Aaron Wright, Primavera De Filippi SSRN, 20 Mar. 2015, papers.ssrn.com/sol3/papers.cfm?abstract_id=2580664.
Ølnes, Svein. “Beyond Bitcoin Enabling Smart Government Using Blockchain Technology.” SpringerLink, Springer, Cham, 5 Sep. 2016, link.springer.com/chapter/10.1007/978-3-319-44421-5_20.

What is claimed is:

1. A method, comprising:
providing an architecture in which a smart contract is made independently from a blockchain in which the smart contract is built on; and
storing the smart contract.
